(19) United States
(12) Patent Application Publication
(10) Pub. No.: US 2026/0160940 A1
(43) Pub. Date: Jun. 11, 2026

(54) MULTI-BAND APERTURE FOR HIGH-SPEED VEHICLE

(71) Applicant: Textron Systems Corporation, Hunt Valley, MD (US)

(72) Inventors: Michael Robert Favaloro, Amesbury, MA (US); James Gerard Crowley, Arlington, MA (US); Kenna Lynn Biddle, Wichita, KS (US)

(21) Appl. No.: 19/410,711

(22) Filed: Dec. 5, 2025

Related U.S. Application Data
(60) Provisional application No. 63/728,784, filed on Dec. 6, 2024.

(51) Int. Cl. G02B 6/06; B64G 1/00; B64G 1/58; B64G 1/62; B64G 1/66

(52) U.S. Cl. CPC G02B 6/06; B64G 1/006; B64G 1/58; B64G 1/62; B64G 1/66

(57) ABSTRACT

A dual-band aperture for a high-speed vehicle includes a substrate composed of a radiofrequency (RF)-transparent material. The substrate has an inner surface arranged to face an internal region of the vehicle and an outer surface arranged to face an environment outside the vehicle. The dual-band aperture further includes multiple, spaced-apart rods composed of an electro-optical/infrared (EO/IR)-transparent material. The rods extend through the substrate between the inner surface and the outer surface to provide EO/IR paths through which the environment outside the vehicle can be imaged.

### CROSS-REFERENCE TO RELATED APPLICATIONS

This application claims the benefit of U.S. Provisional Patent Application No. 63/728,784 , filed Dec. 6, 2024, the contents and teachings of which are incorporated herein by reference in their entirety.

### BACKGROUND

High-speed vehicles, such as rockets, capsules, and ascent vehicles, are designed for reentry into the earth's atmosphere and/or ascent through the earth's atmosphere at high speed. Such vehicles contain various instruments for sensing their environments. For example, a vehicle may contain a global positioning system (GPS) receiver for sensing its location, a radar transducer for detecting nearby objects, and/or radiofrequency (RF) circuitry for enabling wireless communication between the vehicle and an external control station. The vehicle may further include one or more cameras for detecting surrounding objects. The cameras may be sensitive to electro-optical (EO; visible) light and/or infrared (IR) light. For example, a camera may include a sensor sensitive to both EO and IR light, i.e., an “EO/IR” sensor. The term “reentry” as used herein is intended to cover not only the return of a vehicle into the earth's atmosphere, but also an original entry of the vehicle into the atmosphere, such as may occur when the vehicle is deployed from a space station or other body in space

To enable the passage of RF and EO/IR waves between the high-speed vehicle and its environment, the vehicle may include a pair of apertures. An “aperture” as used herein is a solid, heat-resistant structure that is highly transparent to a particular band or set of bands of electromagnetic radiation. For example, an RF aperture may be composed of a heat-resistant material that is transparent to RF waves within a desired frequency range (e.g., that of GPS, radar, satellite communication, etc.), while an EO/IR aperture may be composed of a heat-resistant material that is transparent to optical and infrared waves. Apertures like the ones described above are typically disposed at an outer surface or skin of a rocket, where they have unobstructed views of the outside environment. This placement also subjects the apertures to the extreme stresses of reentry.

### SUMMARY

Certain embodiments are directed to a dual-band aperture for a high-speed vehicle. The dual-band aperture includes a substrate composed of a radiofrequency (RF)-transparent material. The substrate has an inner surface arranged to face an internal region of the vehicle and an outer surface arranged to face an environment outside the vehicle. The dual-band aperture further includes multiple, spaced-apart rods composed of an electro-optical/infrared (EO/IR)-transparent material. The rods extend through the substrate between the inner surface and the outer surface to provide EO/IR paths through which the environment outside the vehicle can be imaged.

According to one or more further embodiments, the substrate is composed of a quartz-fiber reinforced composite material.

According to one or more further embodiments, the substrate has a thickness that is a multiple of one-half a wavelength of a design RF frequency of signals to be sent or received by the high-speed vehicle to within ten percent of the wavelength.

According to one or more further embodiments, the substrate has a thickness that is between one and eight centimeters.

According to one or more further embodiments, the rods are composed of one of sapphire or fused dielectric quartz.

According to one or more further embodiments, the rods have a diameter between two and ten millimeters.

According to one or more further embodiments, the rods extend through the substrate past the inner surface to provide attachment points for optical fibers.

According to one or more further embodiments, the substrate is composed of a laminate outer layer, a foam middle layer, and a laminate inner layer.

According to one or more further embodiments, the substrate is composed of a quartz-fiber reinforced composite material and the rods are composed of fused dielectric quartz.

According to one or more further embodiments, the dual-band aperture further includes a cover that extends over the substrate, the cover constructed and arranged to jettison from the vehicle after a hottest phase of reentry.

According to one or more further embodiments, the cover has a thickness that is a multiple of one-half a wavelength of a design RF frequency of signals to be sent or received by the high-speed vehicle to within ten percent of the wavelength.

According to one or more further embodiments, the dual-band aperture further includes a cover that extends over the substrate, the cover constructed and arranged to ablate away during a hottest phase of reentry.

According to one or more further embodiments, the outer surface of the substrate has a conical shape that is continuous with a conical nose cone of the vehicle.

Other embodiments are directed to a high-speed vehicle. The vehicle includes a nose cone having a dual-band aperture for enabling instrumentation within the nose cone to sense an environment outside the vehicle. The dual-band aperture includes a substrate composed of a radiofrequency (RF)-transparent material. The substrate has an inner surface arranged to face an internal region of the vehicle and an outer surface arranged to face the environment outside the vehicle. The dual-band aperture further includes multiple, spaced-apart rods composed of an electro-optical/infrared (EO/IR)-transparent material. The rods extend through the substrate between the inner surface and the outer surface to provide EO/IR paths through which the environment outside the vehicle can be imaged.

According to one or more further embodiments of the high-speed vehicle, the nose cone has a conical shape, and the outer surface of the substrate has a conical shape that is continuous with the conical shape of the nose cone.

According to one or more further embodiments, the high-speed vehicle further includes multiple optical fibers optically coupled to the EO/IR-transparent rods.

According to one or more further embodiments of the high-speed vehicle, the substrate is composed of a quartz-fiber reinforced composite material.

According to one or more further embodiments of the high-speed vehicle, the substrate has a thickness that is a multiple of one-half a wavelength of a design RF frequency of signals to be sent or received by the high-speed vehicle to within ten percent of the wavelength.

According to one or more further embodiments of the high-speed vehicle, the rods are composed of one of sapphire or fused dielectric quartz.

According to one or more further embodiments, the high-speed vehicle further includes a cover that extends over the substrate, the cover constructed and arranged to ablate away or to jettison from the vehicle during reentry.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a block diagram of an example high-speed vehicle according to one or more embodiments, as well as an example environment in which embodiments of the improved technique can be practiced.

FIG. 2 is an isometric view of an example dual-band aperture for the vehicle of FIG. 1 according to one or more embodiments.

FIG. 3 is a cross-sectional view of the dual-band aperture of FIG. 2 taken along line A-A of FIG. 2.

FIG. 4 is a cross-sectional view of a dual-band aperture wherein a substrate is composed of a multi-layer, laminate structure, according to one or more embodiments.

FIG. 5 is a cross-sectional view of a dual-band aperture wherein fiberoptic cables are connected to rods that extend through a substrate, according to one or more embodiments.

FIG. 6 is an isometric view of an example dual-band aperture that includes a cover, according to one or more embodiments.

FIG. 7 is a cross-sectional view of the dual-band aperture and cover of FIG. 4 taken along line B-B of FIG. 6.

FIG. 8 is a perspective view of an example nose cone of a vehicle that includes a dual-band aperture, as viewed from outside the nose cone, according to one or more embodiments.

FIG. 9 is a perspective view of the example nose cone of FIG. 8, which has been divided to reveal an interior of the dual-band aperture according to one or more embodiments.

FIG. 10 is a flowchart showing an example method of manufacturing a dual-band aperture, according to one or more embodiments.

### DETAILED DESCRIPTION

The above-described prior RF apertures and EO/IR apertures enable effective sensing of an environment around a high-speed vehicle. A disadvantage of such apertures, however, is that the materials needed for an effective RF aperture differ from those needed for an effective EO/IR aperture, and the differences in materials needed has given rise to the use of separate assemblies. Separate aperture assemblies result in high cost and space consumption, however. Therefore, there is a need for an aperture that combines an RF-transparent material with an EO/IR-transparent material in a single assembly.

The above need is addressed at least in part by an improved technique that provides a dual-band aperture for a high-speed vehicle. The dual-band aperture includes a substrate composed of a heat-resistant, RF-transparent material and multiple, spaced-apart rods composed of a heat-resistant, EO/IR-transparent material. The substrate has an inner surface arranged to face an internal region of the vehicle, which may house instrumentation, and an outer surface arranged to face an environment outside the vehicle. The rods extend between the inner surface of the substrate and the outer surface of the substrate to provide EO/IR paths through which the environment can be imaged.

According to one or more embodiments, the substrate is composed of a quartz-fiber reinforced composite material, and the rods are composed of sapphire (alumina) or fused dielectric quartz.

According to one or more embodiments, the substrate has a thickness between the inner surface and the outer surface, and the thickness of the substrate is sized to present a phase shift that is a multiple of one-half a wavelength of desired RF signals to be passed through the substrate, plus or minus approximately ten percent of the wavelength. The multiples of one-half wavelength can include a zero multiple.

According to one or more embodiments, the rods have diameters between about 2 mm (millimeters) and 10 mm, which is small enough to resist cracking cause by thermal shock upon reentry, but large enough to provide sufficient optical or IR resolution and to admit sufficient light. The number of rods contained in the dual-band aperture may vary based on photon requirements and diameters of the rods. For example, implementations using smaller-diameter rods may contain a greater number of rods.

Advantageously, the improved technique enables RF signals of desired frequencies to pass efficiently through the dual-band aperture, while further enabling EO/IR signals to pass efficiently through the rods, effectively providing two apertures in the space usually provided for just one aperture, and reducing total cost.

Particular embodiments of the improved technique will now be described. One should appreciate that such embodiments are provided by way of example to illustrate certain features and principles but are not intended to be limiting.

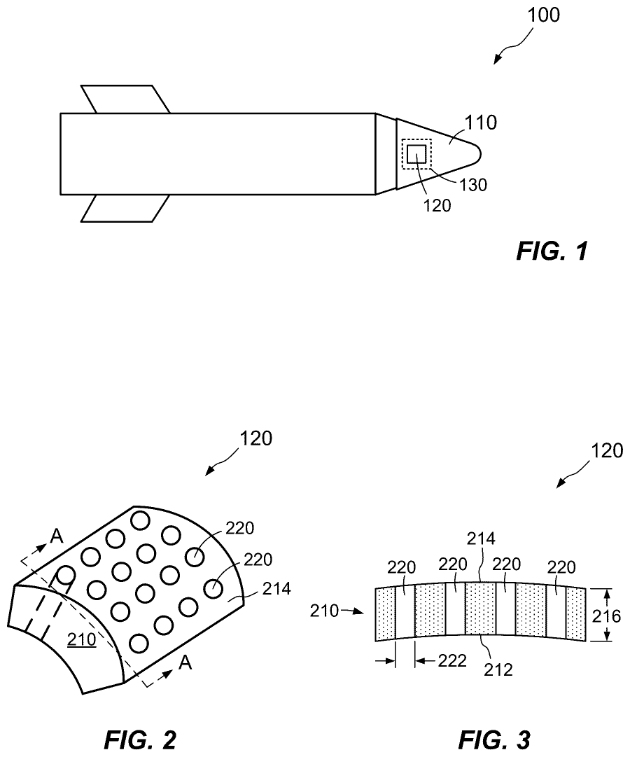

FIG. 1 shows and example high-speed vehicle 100 according to one or more embodiments. In this example, the vehicle 100 is a rocket, which may be designed for reentry into the earth's atmosphere and potentially into the atmospheres of other planetary bodies. The vehicle 100 includes a nose cone 110 having a conical shape. The nose cone 110 has an outer surface designed to withstand the extreme heat and stresses of reentry. The nose cone 110 includes a dual-band aperture 120. Although only a single dual-band aperture 120 is shown, the nose cone 110 may include more than one dual-band aperture 120. In an example, the aperture 120 has an outer surface that is coextensive with the outside of the nose cone 110, such that the aperture 120 follows the same conical shape as the nose cone 110. Preferably, the aperture 120 is not recessed and does not protrude from the nose cone 120, such that the aperture 120 does not impair aerodynamic performance or increase friction upon reentry.

The dual-band aperture 120 provides at least partial transparency, and preferably a high level of transparency, to RF and EO/IR waves. Instrumentation 130 may be placed behind the aperture 120, i.e., inside the nose cone 110 or elsewhere in the vehicle 100, to receive RF radiation and light through the aperture 120, and to transmit RF radiation and light from the vehicle 100 to the environment outside the vehicle 100, if desired. The aperture 120 is effectively a window, which allows electromagnetic radiation to pass both ways.

The instrumentation 130 may include, for example, one or more RF antennas, e.g., for receiving GPS signals and/or for sending and receiving satellite communication and/or other RF communication signals. The instrumentation 130 may further include one or more radar transducers. To detect EO/IR waves, the instrumentation 130 may include one or more focusing elements, such as one or more lenses or mirrors, fiberoptic cables, and digital imaging chips, such as one or more CCD (charge-coupled device) chips or CMOS (complementary metal oxide semiconductor) imaging chips, for example. Such chips may be sensitive to both optical (EO) light and infrared (IR) light, for example.

FIGS. 2 and 3 show an example dual-band aperture 120, according to one or more embodiments. FIG. 2 shows an isometric view, and FIG. 3 shows a cross-sectional view along a section A-A of FIG. 2.

The dual-band aperture 120 includes a substrate 210 having an inner surface 212, an outer surface 214, and a thickness 216. Multiple rods 220 pass through the substrate 210 and extend between the inner surface 212 and the outer surface 214. The rods 220 are generally cylindrical in shape and have diameter 222. In some examples, the diameters 222 of the rods 220 are all the same, but this is not required. The substrate 120 is at least partially transparent to RF signals and the rods 220 are at least partially transparent to EO/IR signals. Although the depicted aperture 120 is rectangular, other shaped apertures are also permitted, such as circular apertures.

According to one or more embodiments, the substrate 210 is composed of a heat-resistant, RF-transparent material, such as a quartz-fiber reinforced composite material. Examples of such materials include AVCO Dense 3D Quartz (AD3DQ), as well as various 3D-printed Quasi-Dielectric Integrated (3D-QDI) structures. When using the AD3DQ approach, quartz fibers may be infiltrated with polysilazane resin and placed in molds to form complex shapes, like the conical shapes described herein. Manufacturing of these shapes may be performed with or without hot isostatic pressing (HIP)

According to one or more embodiments, the thickness 216 of the substrate 210 is established based at least in part on the wavelength of RF signals to be passed through the substrate 210. To this end, the thickness 216 of the substrate 210 is preferably one that provides a phase delay that is an integer multiple of one-half the wavelength of the intended RF signals, to within about ten percent of the wavelength. Such thickness ensures that internal reflections do not cause excessive destructive interference, and thus that RF transmissibility is maximized. For example, the wavelength of a 4 GHz (gigahertz) signal is approximately 7.5 cm, making the optimal thickness 226 of the substrate 210 about 3.75 cm for RF signals of 4 GHz.

It is notable that “zero” counts as an integer multiple of one-half a wavelength, so making the substrate 210 electrically thin (e.g., phase delay of about one-tenth of a wavelength or less) is also a good option. Indeed, electrically thin substrates get closer to zero delay as they are partially ablated during reentry, thus ensuring that RF transmissibility does not decrease (and indeed may increase) as a result of ablation.

According to one or more embodiments, the rods 330 are composed of optical-grade sapphire (alumina) or fused dielectric quartz. The diameters 222 of the rods 220 are preferably in the range of between 2 mm and 10 mm. Diameters 222 on the smaller end of this range provide increased resistance to cracking and crumbling, which can occur with the thermal shock of reentry and can cause a loss of optical performance.

Spacing between different sapphire rods in the substrate 210 is preferably on the order of about two times the diameter 222 of the rods 220, or greater. Sapphire rods have a much higher dielectric constant than the quartz-composite substrate, and thus providing additional distance between adjacent rods 220 helps to ensure that RF waves passing through the substrate 210 are not excessively perturbed by the rods 220. However, if the rods 220 are composed of fused dielectric quartz, the dielectric constant of the rods is much closer to that of the quartz-composite substrate, making spacing between adjacent rods 220 less critical. In addition, fused dielectric quartz has lower melt viscosity than sapphire, which can be advantageous for retaining optical properties if melting can occur during reentry. However, fused dielectric quartz can also change from an amorphous character to a more crystalline character at high temperature, and crystalline quartz can become opaque and impair optical performance. Thus, sapphire may be preferred in some implementations, whereas fused dielectric quartz may be preferred in others.

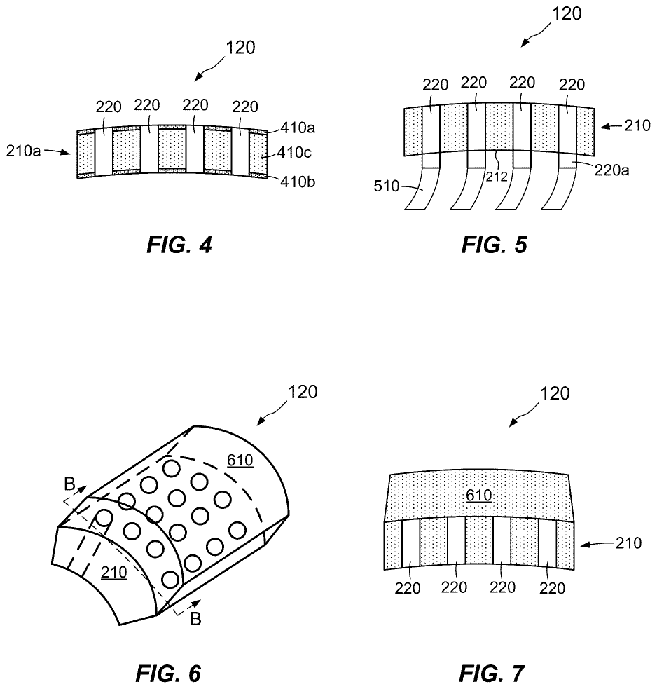

FIG. 4 shows another example of a dual-band aperture 120 according to one or more embodiments. Here, a substrate 210a of the dual-band aperture 120 has a layered structure, which includes an upper laminate layer 410a, a lower laminate layer 410b, and a middle foam layer 410c. The foam layer 410c is mostly air (or empty space), making the overall electrical thickness of the substrate 210a very low, such as one-tenth a wavelength of the desired RF signal or lower. The foam layer 410c also provides a measure of thermal insulation, which can help to prevent the instrumentation 130 (FIG. 1) inside the nose cone 100 from overheating.

FIG. 5 shows yet another example of a dual-band aperture 120 according to one or more embodiments. Here, the EO/IR-transparent rods 220 extend beyond the inner surface 212 of the substrate 210, such that they form convenient attachment points for optical fibers 510. For example, in this arrangement the optical fibers 510 may carry respective views of the outside environment to a common collimation system (not shown) and focusing element (not shown). Images from the different rods 220 may be combined to generate a single focused image which is brighter and has higher resolution than what could be achieved using a single rod 220.

FIGS. 6 and 7 show a further example of a dual-band aperture 120 according to one or more embodiments. In this example, the aperture 120 includes a cover 610, which is constructed and arranged to protect the rods 220 from heat and thermal shock during the hottest phase of reentry, e.g., during a phase in which a hot plasma appears around a leading edge of the nose cone 110. Once the hottest phase of reentry is complete, the cover 610 may be jettisoned or otherwise moved out of the way, such that the rods 220 have a clear view of the environment. In some arrangements, the cover 610, rather than the outer surface 214 of the substrate 210, is coextensive with the conical shape of the nose cone 110, with the substrate 210 itself being recessed.

According to one or more embodiments, the cover 610 is composed of the same type of material as the substrate 210, although this is not required. Also, the cover 610 has a thickness which is preferably an integer multiple of one-half of a wavelength of intended RF signals, ensuring maximum RF transmissibility both when the cover 610 is on and when it is off.

In some examples, the cover 610 may be designed to ablate away during the hottest phase of reentry. In such examples, the cover 610 may be composed of materials such as Avcoat II Ascent thermal protection system (TPS), which are designed to ablate in a controlled manner. A cover 610 that ablates away during reentry does not have to be jettisoned or moved in order to provide visibility to the rods 220, and may thus provide certain advantages. However, RF transmissibility of an ablating cover 610 may be variable, as the thickness of the cover 610 changes for a period of time as ablation progresses.

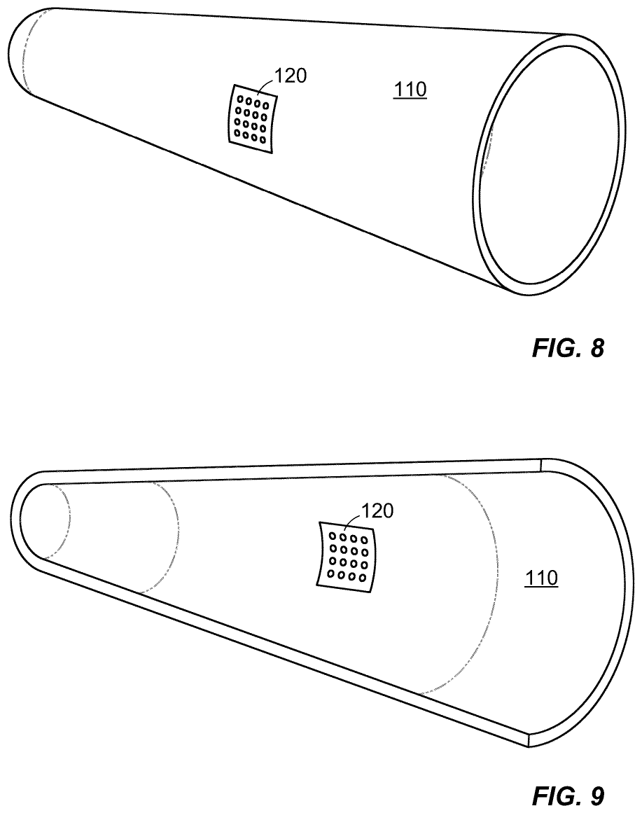

FIGS. 8 and 9 respectively show an outside view (FIG. 8) and an inside view (FIG. 9) of a nose cone 110 that includes a dual-band aperture 120. Although the nose cone 110 is shown as otherwise being empty inside, one should appreciate that this is for illustration only, as the nose cone 110 typically houses the instrumentation 130 and other equipment, such as a computer, other sensors, etc.

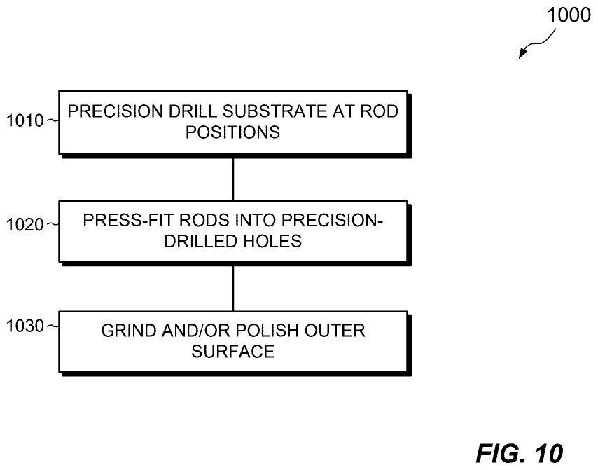

FIG. 10 shows an example method 1000 for manufacturing a dual-band aperture 120 according to one or more embodiments. The method 1000 is typically performed, for example, at an assembly facility using prefabricated materials, such as a prefabricated substrate 210 and prefabricated rods 220. At 1010, the substrate 210 is drilled at specified rod positions, to provide drilled holes having the same diameter 222 as the rods 220. At 1020, the rods 220 are press-fit into the drilled holes, such that they fit tightly within the drilled holes. At 1030, the outer surface 214 of the substrate 210, which may include tips of the rods 220, is ground and/or polished to provide a continuous shape, preferably without bumps or divots at the rod locations.

An improved technique has been described that provides a dual-band aperture 120 for a high-speed vehicle 100. The dual-band aperture 120 includes a substrate 210 composed of a heat-resistant, RF-transparent material and multiple, spaced-apart rods 220 composed of a heat-resistant, EO/IR-transparent material. The substrate 210 has an inner surface 212 arranged to face an internal region of the vehicle 100, which may house instrumentation 130, and an outer surface 214 arranged to face an environment outside the vehicle 100. The rods 220 extend between the inner surface 212 of the substrate 220 and the outer surface 214 of the substrate 220 to provide EO/IR paths, e.g., along the axes of the rods 220, through which the environment can be imaged.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A dual-band aperture for a high-speed vehicle, comprising:
a substrate composed of a radiofrequency (RF)-transparent material, the substrate having an inner surface arranged to face an internal region of the vehicle and an outer surface arranged to face an environment outside the vehicle; and
multiple, spaced-apart rods composed of an electro-optical/infrared (EO/IR)-transparent material, the rods extending through the substrate between the inner surface and the outer surface to provide EO/IR paths through which the environment outside the vehicle can be imaged.

2. The dual-band aperture of claim 1, wherein the substrate is composed of a quartz-fiber reinforced composite material.

3. The dual-band aperture of claim 2, wherein the substrate has a thickness that is a multiple of one-half a wavelength of a design RF frequency of signals to be sent or received by the high-speed vehicle to within ten percent of the wavelength.

4. The dual-band aperture of claim 2, wherein the substrate has a thickness that is between one and eight centimeters.

5. The dual-band aperture of claim 2, wherein the rods are composed of one of sapphire or fused dielectric quartz.

6. The dual-band aperture of claim 5, wherein the rods have a diameter between two and ten millimeters.

7. The dual-band aperture of claim 5, wherein the rods extend through the substrate past the inner surface to provide attachment points for optical fibers.

8. The dual-band aperture of claim 1, wherein the substrate is composed of a laminate outer layer, a foam middle layer, and a laminate inner layer.

9. The dual-band aperture of claim 1, wherein the substrate is composed of a quartz-fiber reinforced composite material and the rods are composed of fused dielectric quartz.

10. The dual-band aperture of claim 1, further comprising a cover that extends over the substrate, the cover constructed and arranged to jettison from the vehicle after a hottest phase of reentry.

11. The dual-band aperture of claim 10, wherein the cover has a thickness that is a multiple of one-half a wavelength of a design RF frequency of signals to be sent or received by the high-speed vehicle to within ten percent of the wavelength.

12. The dual-band aperture of claim 1, further comprising a cover that extends over the substrate, the cover constructed and arranged to ablate away during a hottest phase of reentry.

13. The dual-band aperture of claim 1, wherein the outer surface of the substrate has a conical shape that is continuous with a conical nose cone of the vehicle.

14. A high-speed vehicle, comprising:
a nose cone having a dual-band aperture for enabling instrumentation within the nose cone to sense an environment outside the vehicle, the dual-band aperture including:
a substrate composed of a radiofrequency (RF)-transparent material, the substrate having an inner surface arranged to face an internal region of the vehicle and an outer surface arranged to face the environment outside the vehicle; and
multiple, spaced-apart rods composed of an electro-optical/infrared (EO/IR)-transparent material, the rods extending through the substrate between the inner surface and the outer surface to provide EO/IR paths through which the environment outside the vehicle can be imaged.

15. The high-speed vehicle of claim 14, wherein the nose cone has a conical shape, and wherein the outer surface of the substrate has a conical shape that is continuous with the conical shape of the nose cone.

16. The high-speed vehicle of claim 14, further comprising multiple optical fibers optically coupled to the EO/IR-transparent rods.

17. The high-speed vehicle of claim 14, wherein the substrate is composed of a quartz-fiber reinforced composite material.

18. The high-speed vehicle of claim 17, wherein the substrate has a thickness that is a multiple of one-half a wavelength of a design RF frequency of signals to be sent or received by the high-speed vehicle to within ten percent of the wavelength.

19. The high-speed vehicle of claim 17, wherein the rods are composed of one of sapphire or fused dielectric quartz.

20. The high-speed vehicle of claim 19, further comprising a cover that extends over the substrate, the cover constructed and arranged to ablate away or to jettison from the vehicle during reentry.
